(19) United States
(12) Patent Application Publication
(10) Pub. No.: US 2013/0330040 A1
(43) Pub. Date: Dec. 12, 2013

(54) WEDGE FILTER FOR OPTICAL SUB-ASSEMBLY FOR TRANSCEIVERS

(71) Applicant: Chin-Tsung WU, Taipei (TW)

(72) Inventor: Chin-Tsung WU, Taipei (TW)

(21) Appl. No.: 13/493,615

(22) Filed: Jun. 11, 2012

(51) Int. Cl. G02B 6/34

(52) U.S. Cl. 385/36

(57) ABSTRACT

A wedge filter for an optical sub-assembly for transceivers includes an incident face and an emission face. The incident face and the emission face contain an angle so as to change the refraction position of the incident light. Accordingly, the optical signal is incident upon the optical fiber of the optical sub-assembly for transceivers by a predetermined inclination angle so as to rectify the incident direction of the light emitted from the light-emitting element to be coaxial with the emission direction of the light of the optical fiber for achieving optical coupling efficiency.

### BACKGROUND OF THE INVENTION

1. Field of the Invention

The present invention relates generally to a wedge filter for an optical sub-assembly for transceivers, which can increase optical coupling efficiency.

2. Description of the Related Art

In an optical fiber communication system, optical sub-assembly for transceivers is an important medium for conversion between optical signals and electrical signals. The optical sub-assembly for transceivers can be classified into bi-direction optical sub-assembly (BOSA) capable of receiving bi-direction signals in the same optical fiber and tri-direction optical sub-assembly (TRI-DI OSA) capable of receiving both digital signals and analog signals and transmitting digital signals.

As shown in FIG. 1, either of the BOSA and TRI-DI OSA has a light-emitting element 10. The optical signal emitted from the light-emitting element 10 is incident upon a plane filter 11 and refracted and coupled to the optical fiber 13 of a light guide structure 12. Accordingly, the optical signal can be transmitted.

As to geometrical optics, the calculation formula of emission angle of light is as follows:

nSIN(θ1)=SIN(θ1+θ2), wherein:
n: refractive index of optical fiber;
θ1: grinding angle of optical fiber on the end face of the fiber stub; and
θ2: angle contained between the axis of optical fiber and the emission direction of light. According to the above formula, theoretically, an optimal path is achievable when the direction of the light incident upon the optical fiber and the direction of the light emitted from the optical fiber, (that is, angle of incidence of light and angle of emission of light θ2), are coaxial with each other.

However, the incident direction of the optical signal emitted from the light-emitting element 10 is collinear with the optical fiber 13 rather than coaxial with the emission direction of the light of the optical fiber 13. This will cause loss of the incident optical signal and needs to be overcome.

### SUMMARY OF THE INVENTION

It is therefore a primary object of the present invention to provide a wedge filter for an optical sub-assembly for transceivers. The wedge filter can change the working refraction angle of the incident light so as to increase optical coupling efficiency.

To achieve the above and other objects, the wedge filter for the optical sub-assembly for transceivers of the present invention includes an incident face and an emission face. The incident face and the emission face contain an angle. After an optical signal emitted from the light-emitting element is incident upon the incident face, an optical signal is refracted and emitted from the emission face in a direction unparallel to the direction of the incident optical signal and inclined from the direction of the incident optical signal by a predetermined inclination angle. Then the emitted optical signal is incident upon the optical fiber by the predetermined inclination angle so as to rectify the incident direction of the light incident upon the optical fiber to be coaxial with the emission direction of the light emitted from the optical fiber for reducing loss of the incident optical signal.

### BRIEF DESCRIPTION OF THE DRAWINGS

The structure and the technical means adopted by the present invention to achieve the above and other objects can be best understood by referring to the following detailed description of the preferred embodiment and the accompanying drawings, wherein:

FIG. 1 is a sectional view showing that a conventional filter is installed in an optical sub-assembly for transceivers, also showing the light paths of the incident optical signal and emitted optical signal;

FIG. 2 is a perspective view of the present invention;

FIG. 3 is a sectional view of the present invention;

FIG. 4 is a sectional view showing that the wedge filter of the present invention is installed in an optical sub-assembly for transceivers, also showing the light paths of the incident optical signal and emitted optical signal, which are coaxial with each other.

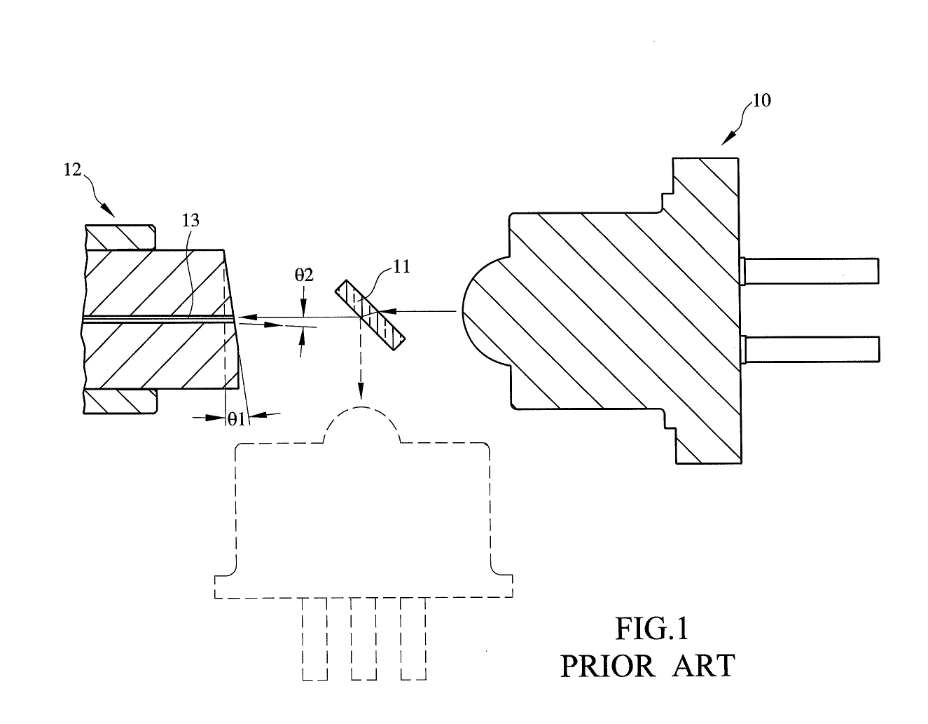

### DETAILED DESCRIPTION OF THE PREFERRED EMBODIMENT

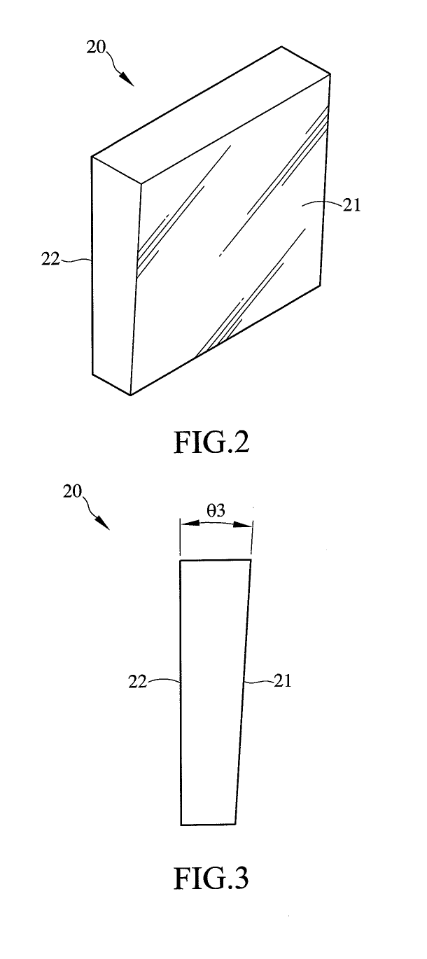

Please refer to FIGS. 2 and 3. The wedge filter 20 for optical sub-assembly for transceivers of the present invention is applicable to BOSA and TRI-DI OSA. The wedge filter 20 includes an incident face 21 and an emission face 22 opposite to the incident face 21. The incident face 21 and the emission face 22 contain an angle θ3, (that is, the wedge angle). The angle is an acute angle. Therefore, the incident face 21 and the emission face 22 are unparallel to each other. Preferably, the angle θ3 ranges from one degree to 25 degrees.

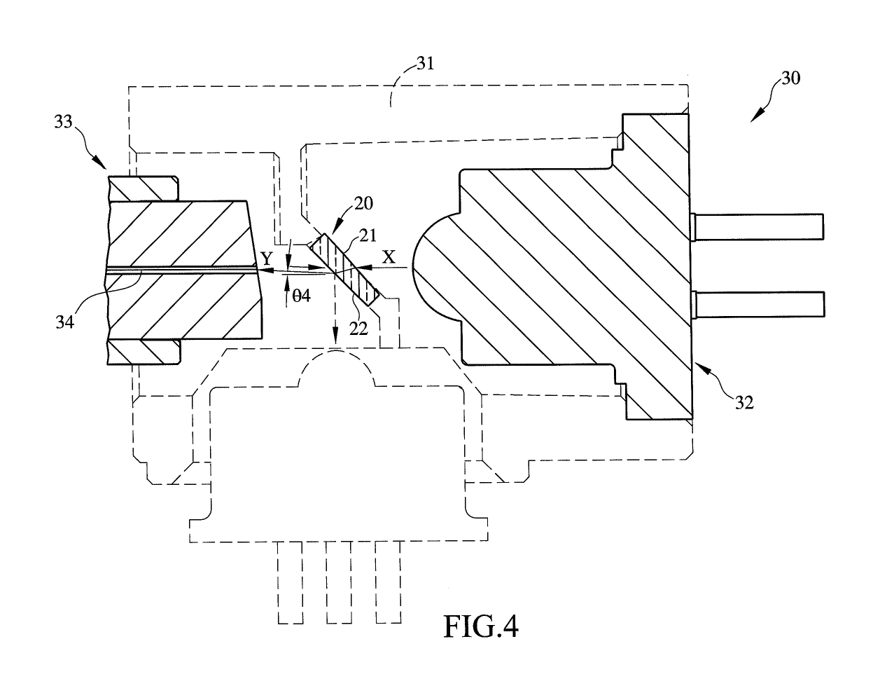

FIG. 4 is a sectional view showing that the wedge filter 20 of the present invention is installed in an optical sub-assembly for transceivers 30. The wedge filter 20 is disposed in a main housing 31 and positioned between a light-emitting element 32 and a light guide structure 33. The incident face 21 of the wedge filter 20 faces the light-emitting element 32, while the emission face 22 faces the light guide structure 33. After the optical signal X emitted from the light-emitting element 32 is incident upon the incident face 21 of the wedge filter 20, the incident optical signal will go into the wedge filter 20. As aforesaid, the incident face 21 and the emission face 22 contain the wedge angle θ3 and are unparallel to each other. Therefore, the optical signal Y is refracted and emitted from the emission face 22 in a direction unparallel to the direction of the incident optical signal X and inclined from the direction of the incident optical signal X by a predetermined inclination angle θ4. The optical signal Y is incident upon the optical fiber 34 of the light guide structure 33 by the inclination angle θ4. In this case, the incident direction of the light emitted from the light-emitting element 32 is coaxial with the emission direction of the light of the optical fiber 34 to meet the calculation formula of emission angle of light. Therefore, the optical signal emitted from the light-emitting element 32 can be mass-accumulated and coupled to the optical fiber 34 to reduce coupling loss and greatly increase optical coupling efficiency.

According to the above arrangement, the wedge filter 20 of the present invention can change the working refraction angle so as to rectify the incident direction of the light emitted from the light-emitting element 32 to be coaxial with the emission direction of the light of the optical fiber 34 for achieving a best optical coupling efficiency.

The present invention has been described with the above embodiment thereof and it is understood that many changes and modifications in the above embodiment can be carried out without departing from the scope and the spirit of the invention that is intended to be limited only by the appended claims.

What is claimed is:

1. A wedge filter installed in an optical sub-assembly for transceivers, the optical sub-assembly for transceivers including a light-emitting element and a light guide structure having an optical fiber for transmitting optical signal, the wedge filter being positioned between the light-emitting element and the light guide structure, the wedge filter comprising:
an incident face facing the light-emitting element; and
an emission face facing the light guide structure, the incident face and the emission face containing an angle, whereby after an optical signal X emitted from the light-emitting element is incident upon the incident face, an optical signal Y is refracted and emitted from the emission face in a direction unparallel to the direction of the incident optical signal X and inclined from the direction of the incident optical signal X by a predetermined inclination angle, then the optical signal Y being incident upon the optical fiber by the predetermined inclination angle so as to rectify the incident direction of the light emitted from the light-emitting element to be coaxial with the emission direction of the light of the optical fiber for enhancing optical coupling efficiency.

2. The wedge filter as claimed in claim 1, wherein the incident face is opposite to the emission face.

3. The wedge filter as claimed in claim 1, wherein the angle contained between the incident face and the emission face is not larger than 90 degrees.

4. The wedge filter as claimed in claim 1, wherein the angle contained between the incident face and the emission face ranges from one degree to 25 degrees.
